(19) United States
(12) Patent Application Publication
(10) Pub. No.: US 2010/0171303 A1
(43) Pub. Date: Jul. 8, 2010

(54) MULTI-ANGLE JOINT

(75) Inventors: Eliezer Krausz, Tel Aviv (IL); Avi Chiproot, Kfar-Saba (IL)

Correspondence Address: DEKEL PATENT LTD., DAVID KLEIN, BEIT HAROF'IM, 18 MENUHA VENAHALA STREET, ROOM 27, REHOVOT, 76209, IL

(73) Assignee: KRAUSZ ELIEZER, TEL AVIV (IL)

(21) Appl. No.: 12/663,543

(22) PCT Filed: Jun. 12, 2008
(86) PCT No.: PCT/IL08/00807

§ 371 Date: Dec. 8, 2009

(51) Int. Cl. F16L 27/00

(52) U.S. Cl. 285/184

(57) ABSTRACT

The present invention relates to the interconnection of conduits and pipelines carrying liquids or gasses. The invention provides a low-cost multi-angle adjustable joint and a coupling suitable for round-section piping, tubing, air ducts or drainage. Each extremity of the coupling is arranged for connection to an adjacent pipe, filter, pump or other fluid flow item. The invention provides a multi-angle adjustable joint for two section pipes, tubes or ducts, comprising; a first round pipe provided with a first round inner flange disposed at an angle relative to the pipe axis: A second round pipe provided with a second round inner flange disposed at an angle relative to the second pipe axis, the second inner flange being sized to match the first inner flange, and when the two flanges are oriented face-to-face the pipes can be steplessly rotated relative to each other to a position wherein the largest total angle between the axes of the two pipes is at least 30° and is the sum of the two angles. An elastomer seal element extending along the outer edges of both flanges, disposed inside a tightenable clamp member enveloping the major portion of said seal element.

The present invention relates to the interconnection of conduits and pipelines carrying liquids or gasses.

More particularly, the invention provides a low-cost multi-angle adjustable joint and a coupling suitable for round-section piping, tubing, air ducts or drainage. The coupling is particularly advantageous for use in the larger sizes, above about 100 mm. Each extremity of the coupling is arranged for connection to an adjacent pipe, filter, pump or other fluid flow item.

Known today are three groups of angle pipe joints.

A first group comprises joints including a bendable central component. The well-known reinforced rubber hose can be included in this category, although large diameter hose is usually unavailable or too expensive in comparison with alternative methods, and the hose inner passage will be restricted on bending unless metal restraint members are added. Examples of metal flexible pipe joints are seen in U.S. Pat. No. 4,965,357 to Brinegar who proposes metal bellows, and in U.S. Pat. No. 6,059,338 to Diederichs who proposes a single peripheral outward bulge made of a thin deformable metal. Both suffer from the disadvantage that the flexible component is thinner than the pipe wall and is liable to be damaged. A further problem is that both designs entail some invasion of the pipe inner diameter causing unwanted flow resistance.

The second group comprises of devices based on one or two ball-joints. A commercial example is the Flexijoint”™ produced by Romac Industries, Inc. By the use of two joints parallel pipeline offset can be achieved. Similarly U.S. Pat. No. Des. 283,833 shows an elbow housing a ball end. The primary problem with this type of valve is that in the larger sizes the joint becomes prohibitively expensive and bulky, as the aperture passing through the ball should equal the inner diameter of the pipe.

The third group encompasses special designs. Examples are seen in U.S. Pat. No. 4,494,777 to Duret and in U.S. Pat. No. 5,101,915 to Witte. These designs allow only limited angular movement, typically less than 10°.

It is therefore one of the objects of the present invention to obviate the disadvantages of prior art angle joints and to provide a joint and a coupling which are moderate in size and cost and are adjustable over a wide angular range of at least ±15°.

It is a further object of the present invention to achieve this while allowing fast opening and closing of the joint and in resetting its angle to another value.

Yet a further object of the present invention is to provide a joint and coupling without invasion of the inner diameter.

The present invention achieves the above objects by providing a multi-angle adjustable joint for two section pipes, tubes or ducts, comprising:
a first round pipe provided with a first round inner flange disposed at an angle A relative to the pipe axis;
a second round pipe provided with a second round inner flange disposed at an angle B relative to the second pipe axis, said second inner flange being sized to match said first inner flange, and when the two flanges are oriented face-to-face said pipes can be steplessly rotated relative to each other to a position wherein the largest total angle C between the axes of the two pipes is at least 30° and is the sum of the angles, A+B; and
an elastomer seal element extending along the outer edges of both flanges, disposed inside a tightenable clamp member enveloping the major portion of said seal element.

In the preferred embodiment of the present invention there is provided a joint as described above, wherein the angle A is equal to the angle B.

In a preferred embodiment of the present invention there is provided a joint as described above, wherein said elastomer seal element is retained in a substantially U form section.

In another preferred embodiment of the present invention there is provided a joint wherein said tightenable clamp member is a U-section metal band, the extremities of said band being formed as two outwardly-extending ears each having at least one aperture, the distance between said ears being reduceable by tightening at least one screw member insertable in said apertures.

In a further preferred embodiment of the present invention there is provided a multi-angle adjustable pipe coupling for two round-section pipes, tubes or round-section ducts, comprising:
a first sleeve provided with a first round inner flange disposed at an angle A relative to the sleeve axis;
a second sleeve provided with a second round inner flange disposed at an angle B relative to the second sleeve axis, said second inner flange being of same outer diameter as said first inner flange, and when said inner flanges are oriented face-to-face said flanges can be rotated relative to each other to a position wherein the total angle C between the axes of the two sleeves is at least 30° and is the sum of the angles A+B; and
an elastomer seal element extending along the outer edges of both flanges, disposed inside a tightenable clamp member enveloping the major portion of said seal element;
wherein said coupling substantially comprises a hollow cylindrical shape and said coupling can be adjusted within a range of bend from zero to at least ±25°.

In a further preferred embodiment of the present invention there is provided a coupling wherein the central split portion substantially comprises the central slice of a hollow sphere and said coupling has a range of bend from zero to at least ±30°.

In yet a further preferred embodiment of the present invention there is provided a coupling wherein the central split portion substantially comprises a pair of hollow cylinders intersecting at an angle of about 145-165° and said coupling has a range of bend from zero to at least 50°.

In a most preferred embodiment of the present invention there is provided a coupling wherein the central split portion is similar to a hollow pear-like shape and said coupling has a range of bend of at least 60°.

In an even most preferred embodiment of the present invention there is provided a coupling wherein the central split portion is similar to a hollow pear like shape and said coupling has a range of bend of at least 90°.

It will be noticed that the angle at which the axis of the joint or coupling can have any value in its range, being steplessly adjustable to the angle desired.

As will be apparent from the drawings, the joint and the coupling have inner flanges which are bent over outwards near the outer perimeter of the pipe or sleeve. Thus no welding is needed and the result is a light-weight, compact and low-cost joint and coupling.

At the outlet and inlet of the coupling there will be seen a flange or pipe connector which are the subjects of our previous patents and are illustrated here only for the sake of completeness. No novelty is claimed for these items with respect to the present invention and they will thus not be described herein in detail.

The invention will now be described further with reference to the accompanying drawings, which represent by example preferred embodiments of the invention. Structural details are shown only as far as necessary for a fundamental understanding thereof. The described examples, together with the drawings, will make apparent to those skilled in the art how further forms of the invention may be realized.

In the drawings:

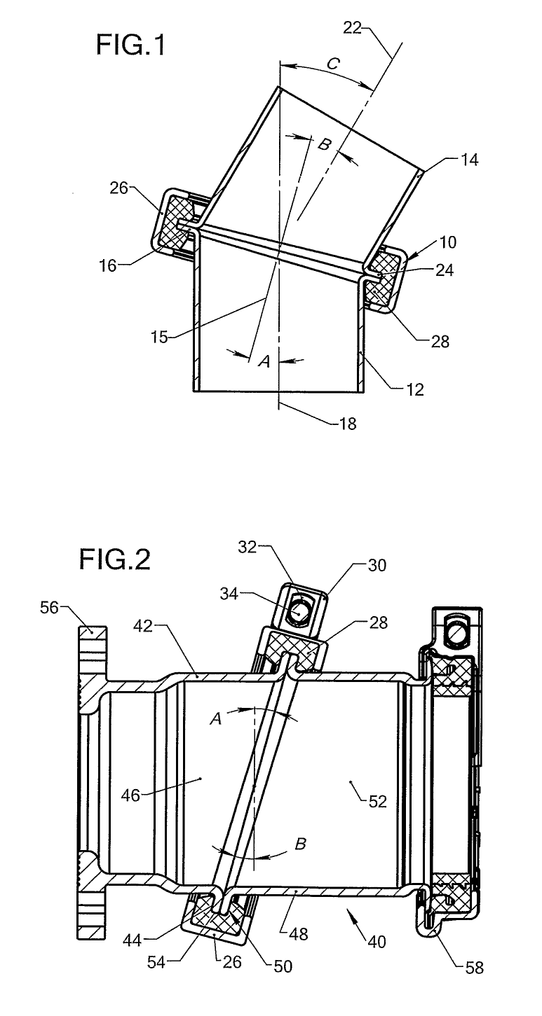

FIG. 1 is a sectioned elevational view of a preferred embodiment of the joint according to the invention;

FIG. 2 is a sectioned elevational view of a first embodiment of a pipe coupling;

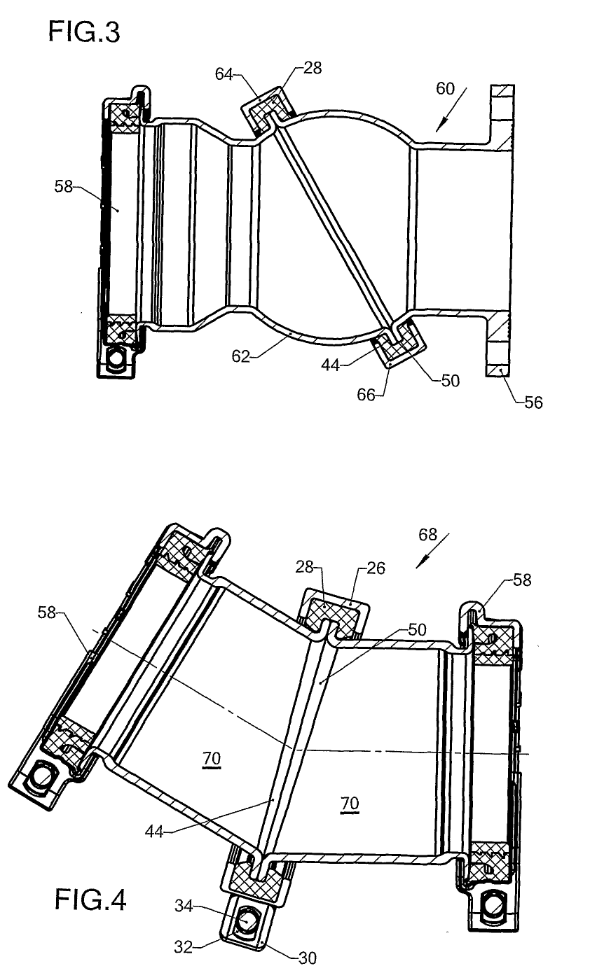

FIG. 3 is a sectioned elevational view of an embodiment having a partially global center section;

FIG. 4 is a sectioned elevational view of a coupling seen in its bended mode;

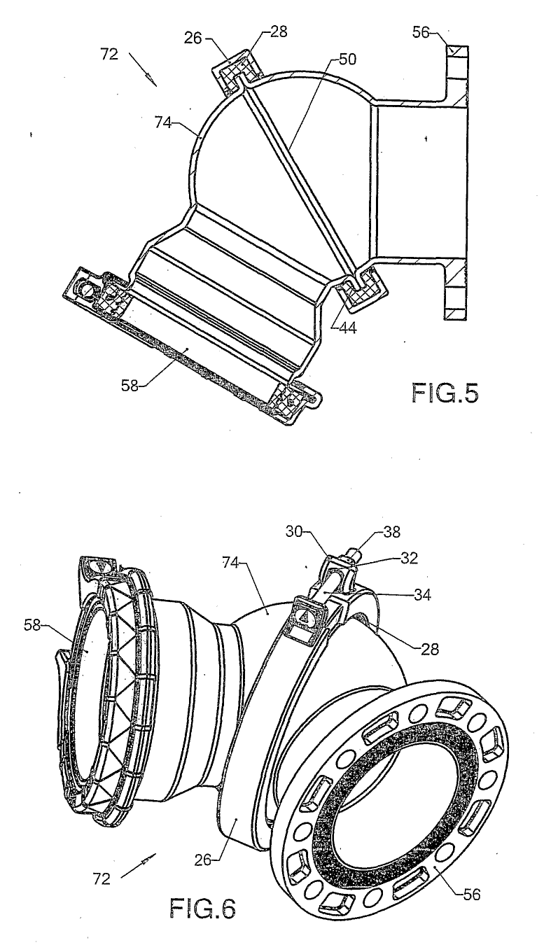

FIG. 5 is a sectioned elevational view of a pear-shaped coupling bent by 45°;

FIG. 6 is a perspective view of the coupling seen in FIG. 5;

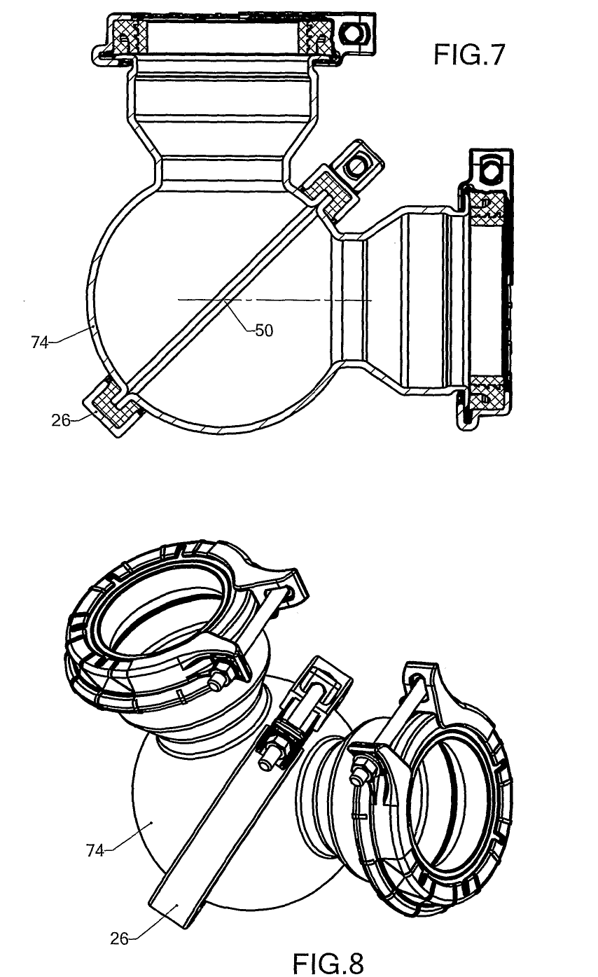

FIG. 7 is a sectioned elevational view of a pear-shaped coupling bent by 90°; and

FIG. 8 is a perspective view of the coupling seen in FIG. 7.

There is seen in FIG. 1 a multi-angle adjustable joint 10 for two round-section pipes, tubes or round-section ducts 12, 14.

A first round pipe 12, terminates in a first round inner flange 16 disposed at an angle A relative to the pipe axis 18. A line perpendicular to the flange face is seen at 15. In the example shown the angle A between the pipe axis 18 and the perpendicular 15 is about 15°.

A second round pipe 14 has a second round inner flange 20 disposed at an angle B relative to the second pipe axis 22. The second inner flange 20 is sized to match the first inner flange 16. The pipes 12, 14 seen in the present embodiment have thin walls, and the flanges 16, 20 were formed by forming the pipe extremity 24 outwards.

When the two flanges 16, 20 are oriented face-to-face as seen in the drawing while the external clamp 26 is released, one of the pipes 12, 14 can be steplessly rotated relative to the remaining pipe. The pipes 12, 14 are shown in a position wherein the largest total angle C between the axes 18, 22 of the two pipes is about 30°, being the sum of the angles, A+B. By revolving one of the pipes 14 about 180° the joint is set to near zero, this being the difference between A and B. In the preferred embodiment illustrated the angle A is equal to the angle B, so the joint 10 can be set at zero or at any angle up to a maximum of C°.

An elastomer seal element 28 extends along the outer edges 24 of both flanges 16, 20. The seal element 28 is disposed inside a U-form section metal band clamp member 26. The metal clamp member 26 envelopes the major portion of the seal element 28.

The elastomer seal element 28 prevents leaks, and is retained in the clamp member 26, which forces the seal element 28 into contact with the flange edges 24 as well as preventing axial forces from separating the two pipes 12, 14.

As will be seen in FIG. 2 the extremities of the band 26 are formed as two outwardly-extending ears 30 each having at least one aperture 32. By tightening a screw 34 inserted through the ear aperture 32, or by tightening the nut 38 partly visible in FIG. 6, the distance between the ears 30 is reduced. Thus pressure is applied to the seal element 28 in a compact and low cost manner.

It should be noted that the two parts of the joint could be rotated by 360° relative to each other.

With reference to the rest of the figures, similar reference numerals have been used to identify similar parts.

Referring now to FIG. 2, there is seen a multi-angle adjustable pipe coupling 40 for joining two round-section pipes, tubes or round-section ducts 12, 14 seen in FIG. 1.

A first sleeve 42 is provided with a first, round, inner flange 44, disposed at an angle A relative to a particular to the sleeve axis 46.

A second sleeve 48 is provided with a second round inner flange 50 disposed at an angle B relative to the second sleeve axis 52. The second inner flange 52 is of same outer diameter as the first inner flange 44. When the inner flanges 44, 50 are oriented face-to-face the flanges can be rotated relative to each other to a position wherein the total angle C between the axes 46, 52 of the two sleeves can be set within a range of bend from zero, as seen in the figure, to at least 25°. C is the sum of the angles A+B.

An elastomer seal element 28 extends along the outer edges 54 of both inner flanges 44, 50 disposed inside a tightenable clamp member 26 enveloping the major portion of the seal element.

Ignoring the flanges 44, 50 the seal element 28 and the 26 band clamp member the coupling is shown as a substantially hollow cylindrical shape.

The sleeve 42 terminates in a standard prior-art flange 56 while the second sleeve 48 is fitted with a band clamp connector 58. It is within the scope of the invention to have both sides with a flange 56 or a band clamp connector.

FIG. 3 illustrates a coupling 60 wherein the central split portion 62 substantially comprises the central slice of a hollow sphere. The rounded shape of the cross-section seen in the figure allows the U-form section metal band external clamp member 64 to be slightly deeper yet the legs 66 of the U-shape will not contact the coupling body. Consequently the coupling 60 has a range of bend from zero to at least ±30° in its median position already shows a bend angle of about 25°, as seen in the central split portion 70. This portion is shaped substantially as a pair of hollow cylinders intersecting at an angle of about 155°. Thus the coupling has a range of bend from about zero to at least 50°.

Seen in FIG. 4 is a coupling 68 which is generally similar to the coupling 40 seen in FIG. 1. The coupling 68 is larger and both sleeves terminate in a band clamp connector 58. The coupling 68 has two straight sections 70 and is seen set at angle of about 30°.

Where a larger bend angle is desired a coupling 72 such as is now seen in FIG. 5 is used. The central split portion 74 is similar to a hollow pear-like shape. The coupling 72 has a range of bend from zero to at least 60°.

FIG. 6 is provided for illustrative purposes. The coupling 72 has been described with reference to FIG. 5.

Where an even larger bend angle is desired a coupling 72 such as is now seen in FIG. 7 is used. The central split portion 74 is similar to a hollow pear-like shape. The coupling 72 has a range of bend from zero to at least 90°.

FIG. 8 is provided for illustrative purposes. The coupling 72 has been described with reference to FIG. 7.

The scope of the described invention is intended to include all embodiments coming within the meaning of the following claims. The foregoing examples illustrate useful forms of the invention, but are not to be considered as limiting its scope, as those skilled in the art will be aware that additional variants and modifications of the invention can readily be formulated without departing from the meaning of the following claims.

1-11. (canceled)

12. A multi-angle adjustable pipe coupling for two round-section pipes, tubes or round-section ducts, comprising:
a first sleeve provided with a first round inner flange disposed at an angle A relative to a longitudinal axis of said first sleeve;
a second sleeve provided with a second round inner flange disposed at an angle B relative to a longitudinal axis of said second sleeve, and when said inner flanges are oriented face-to-face at a central split portion, said flanges can be rotated relative to each other to a position wherein the total angle C between the longitudinal axes of the two sleeves ranges from 0° to at least 30° and is the sum of the angles A+B; and
an elastomer seal element extending along the outer edges of both flanges, disposed inside a tightenable clamp member enveloping the major portion of said seal element; wherein said coupling substantially comprises a hollow cylindrical shape and said coupling can be adjusted within a range of bending, and wherein said central split portion is non-cylindrical in shape.

13. The coupling as claimed in claim 12, wherein said coupling can be adjusted within a range of bending from 0° to at least ±25°.

14. The coupling as claimed in claim 12, wherein said second inner flange is of same outer diameter as said first inner flange.

15. The coupling as claimed in claim 12, wherein the central split portion substantially has a shape of a hollow sphere and said coupling has a range of bend from zero to at least ±30°.

16. The coupling as claimed in claim 12, wherein the central split portion substantially has a shape formed by a pair of hollow cylinders intersecting at an angle of about 145-165° and said coupling has a range of bend from zero to at least 50°.

17. The coupling as claimed in claim 12, wherein the wherein the central split portion has a hollow pear-like shape and said coupling has a range of bend from zero to at least 60°.

18. The coupling as claimed in claim 12, wherein the wherein the central split portion has a hollow pear-like shape and said coupling has a range of bend from zero to at least 90°.

19. The coupling as claimed in claim 12, wherein said angle A is equal to said angle B.

20. The coupling as claimed in claim 12, wherein said elastomer seal element is retained in a substantially U form section.

21. The coupling as claimed in claim 12, wherein said tightenable clamp member is a U-section metal band, the extremities of said band being formed as two outwardly-extending ears each having at least one aperture, the distance between said ears being reduceable by tightening at least one screw member insertable in said apertures.
